(19) United States
(12) Patent Application Publication
(10) Pub. No.: US 2012/0083253 A1
(43) Pub. Date: Apr. 5, 2012

(54) EXCHANGE OF ELECTRONIC BUSINESS CARDS BETWEEN STATIONS

(75) Inventor: Alexandra Esmeralda Van Der Vis-Kruijswijk, Harmelen (NL)

(73) Assignee: HEALTHY SWEET MARKETING, Harmelen (NL)

(21) Appl. No.: 13/320,305

(22) PCT Filed: May 4, 2010
(86) PCT No.: PCT/NL10/50262

§ 371 Date: Dec. 23, 2011

(30) Foreign Application Priority Data
May 13, 2009 (NL) 1036954

(51) Int. Cl. H04W 4/12

(52) U.S. Cl. 455/414.1

(57) ABSTRACT

A mobile station arranged for receiving an electronic business card, for adding a user instruction to the electronic business card, and for storing the resulting combination on a server provided for this purpose, which mobile station is also arranged for transmitting an electronic business card with a user instruction coupled thereto. A server specially arranged for receiving an electronic business card with a user note from a mobile station, and furthermore arranged for generating a reminder message based on the user note and for sending this message to the mobile station.

### PRIORITY CLAIM

This patent application is a U.S. National Phase of International Patent Application No. PCT/NL2010/050262, filed 4 May 2010, which claims priority to Netherlands Patent Application No. 1036954, filed 13 May 2009, the disclosures of which are incorporated herein by reference in their entirety.

### FIELD

Disclosed embodiments relate to the exchange of electronic business cards between mobile stations, for example mobile telephones.

### BACKGROUND

Many paper business cards are exchanged in the business world. These paper business cards have a number of disadvantages. For example, it is labour-intensive to copy business information from paper business cards into other systems such as mobile telephones, PDAs, e-mail programmes on the computer, and the like. People receive many business cards during certain events. It is accordingly desirable to allow an exchange of business cards by electronic means. Systems for the electronic exchange of business cards have indeed become available by now.

An example of such a system is described in international patent publication WO2005/040986, which describes the transfer of a hyperlink to an electronic business card between two mobile telephones. The information belonging to business cards changes fast. It is further described in the cited patent publication that the information of the electronic business card can be updated, so that a receiver always has updated contact information at his/her disposal.

A note is often added to the paper business card when the latter is exchanged, i.e. the note is written on the paper card as a reminder of what is to be done with the obtained contact information at a point in time later than that at which the business card was received. This is not possible with the electronic business cards according to the prior art as described in WO2005/040986. It is accordingly an object of the present invention to overcome this disadvantage.

### SUMMARY

Disclosed embodiments provide a mobile station of a first user designed for the exchange of electronic business cards with another mobile station, wherein the first mobile station has a processing unit for controlling the mobile station and a first communication unit connected to the processing unit and designed for receiving a first electronic business card from the other mobile station, i.e. from a second user. The received first electronic business card can be displayed by means of a display unit connected to the processing unit. The first user can enter a first user instruction by means of a user data input unit, and a storage unit connected to the processing unit can combine the first electronic business card with the first user instruction and store this combination. The first electronic business card with the associated first user instruction can be sent to a server by a second communication unit connected to the processing unit, in which server the first electronic business card and the associated first user instruction can be stored, for example in a database. Thus electronic business cards originating from a different user can be provided with a user instruction, and the resulting combination can be stored in the mobile station itself and in a data base on a server for future reference.

The storage unit of the mobile station may also contain a second electronic business card, for example that of the first user of the mobile station him/herself, while the user data input unit is also designed for enabling the first user to enter a second user instruction, the processing unit then adding the second user instruction to the second electronic business card, while the first communication unit is further designed for transmitting the combination of the second electronic business card and the second user instruction to the other mobile station of the second user or some other user. This allows a user to add instruction to an electronic business card before the latter is exchanged, in which case it is the sender of the electronic business card who takes the initiative to add the user instruction.

In one disclosed embodiment, the reception or transmission of the first or the second electronic business card from or to the other mobile station, respectively, by the first communication unit also comprises the reception or transmission of a reference to the first or the second electronic business card present on the server. This allows the exchange of information to be very brief, while the information that a user wants to consult on his/her mobile telephone can be retrieved very quickly from the server by means of the second communication unit.

In another disclosed embodiment, the first communication unit is furthermore designed for receiving from the other mobile station a third user instruction belonging to the first business card. This allows the mobile station to receive the first business card from the other user with a third user instruction already attached thereto by the second user of the other mobile station before the transmission of his/her business card.

In yet another disclosed embodiment, the user data input unit is also designed for modifying the third user instruction. This allows, for example, to supplement or change the third user instruction as put in by the second user into a user instruction that meets the demands of the first user who receives the business card and the associated user instruction.

In a further disclosed embodiment, the user data input unit is also designed for enabling the user to select from a list at least one from among the first, the second, and the third user instruction. This makes it possible to choose very quickly a pre-programmed user instruction from a list. This may be combined with or expanded into a modification of the user instruction in accordance with the preceding embodiment.

In another disclosed embodiment, at least one from among the first, the second, and the third user instruction may comprise an instruction to be executed by at least one from among the processing unit of the mobile station and a processing unit of the server, the respective processing unit being designed for executing such an instruction. This has the advantage that the user receiving such an instruction can have the mobile station or the server carry out the user instruction by means of a single action, or the user instruction is even carried out fully automatically without any user intervention. An example of this is that an instruction from the first user, who sends a business card, is at the same time an instruction to the second user on his/her part to send business cards through his/her mobile telephone, whereby the exchange of business cards is further speeded up.

In yet another disclosed embodiment, the executable instruction may comprise a reminder instruction, while the processing unit is further designed for generating a reminder message that can be shown on the display unit. The reminder message may comprise, for example, a date and/or a time at which it is desirable for the mobile telephone to remind the user to look up the received electronic business card and to take a certain action.

In a further disclosed embodiment, the generation of the reminder message may comprise a reception of a reminder message from the server by the second communication unit of the mobile station. In this case, accordingly, the mobile station does not need to generate the reminder message itself, but can leave this to the server on which the electronic business card with the associated user instruction is stored.

In another disclosed embodiment, the input unit is further designed for enabling the user to enter a selection request for receiving a selection of reminder messages, wherein the second communication unit is further designed for transmitting the selection request to the server and receiving the selection from the server, and wherein the display unit is further designed for displaying the selection. This allows management of the electronic business cards and their associated stored user instructions and to obtain overviews for the processing thereof.

In yet another disclosed embodiment, the selection request comprises an indication of at least one user, which allows to retrieve an electronic business card and a reminder instruction of a certain user from the server.

In a further disclosed embodiment, the first communication unit of the mobile station is specially constructed for communication over a short distance. This provides the facility that the exchange of electronic business cards and the associated user instructions will take place only when the mobile stations between which the exchange is to take place are at a short distance from one another. This ensures that the confidential character of the exchange of personal data laid down on the electronic business cards is safeguarded and an unwanted or accidental exchange is prevented.

Disclosed embodiments also provide a server specially designed for cooperating with a mobile station as described above, wherein the server comprises a processing unit for controlling the server, a communication unit for receiving from a mobile station a combination of an electronic business card and an associated instruction, and a storage unit designed for storing the electronic business card and the associated user instruction. In this manner the electronic business card received by the first user, whether or not provided with a user instruction, or with a user instruction added by the first user him/herself, is stored in the storage unit of the server.

According to the disclosed embodiments, the processing unit is designed for generating at least one reminder message. The reminder message comprises the business card and the associated user instruction, and the communication unit is furthermore designed for transmitting the reminder message to the mobile station. This enables a user to store electronic business cards and user instructions by means of his/her mobile telephone in combination with the server, the user receiving reminder messages belonging to the stored business cards as well as the user instruction from the server on his/her mobile telephone, so that the user can respond to the stored user instruction.

In one disclosed embodiment of the server, the processing unit and the storage unit are furthermore arranged for composing a selection of reminder messages, and the communication unit is furthermore designed for transmitting this selection of reminder messages to the mobile station. This simplifies the management of the stored business cards in that a selection can be made in accordance with a predetermined selection criterion, so that only desired reminder messages are transmitted. In an embodiment of the invention, the communication unit is furthermore arranged for receiving a request from the mobile station to transmit a selection of not yet processed reminder messages. It is prevented thereby that reminder messages already dealt with are transmitted once more to the mobile station.

In another disclosed embodiment, the communication unit is furthermore arranged for receiving a selection request from the mobile station to transmit a selection of reminder messages associated with at least one user, the processing unit and storage unit being designed for making a selection on the basis of the at least one user on behalf of whom an electronic business card is stored. The selection criterion here is the at least one user, in which case the mobile station may be designed for making a selection from a list of users on behalf of whom electronic business cards and associated user instructions have been stored. This also simplifies the management of the stored electronic business cards and associated user instructions.

In yet another disclosed embodiment, the communication unit is furthermore designed for transmitting the selection of reminder messages at a predetermined moment in time. This enables a user to be reminded of the stored business cards and user instructions at a time that is favourable for this user. Thus, for example, the user may decide to postpone the further dealing with user instruction to the next day.

In a further disclosed embodiment, the user instruction is an instruction that is to be executed by the processing unit of the server, which processing unit is furthermore designed for processing the executable instruction. This provides a possibility of automating the processing of user instructions, so that interventions by the user can be minimised.

In yet another disclosed embodiment, the storage unit is furthermore designed for storing a confirmation check on the execution of the associated user instruction along with the electronic business card, and the communication unit is furthermore designed for receiving the confirmation check from the mobile station such that electronic business cards with a confirmation check are not included in the selection. It is thus possible to check off the reminder messages and the associated user instructions during the processing thereof, so that the relevant business cards and user instructions will not appear again in a selection for processing on the mobile station.

### BRIEF DESCRIPTION OF THE DRAWINGS

FIG. 1 diagrammatically shows two mobile stations and a server cooperating in accordance with the disclosed embodiments;

FIG. 2 is a block diagram of a mobile station according to one disclosed embodiment;

FIG. 3 is a block diagram of a server according to another disclosed embodiment;

FIG. 4a is a process flowchart of a mobile station according to one disclosed embodiment;

FIG. 4b is a second process flowchart of a mobile station according to another disclosed embodiment;

FIG. 5a is a process flowchart of a server according to a disclosed embodiment;

FIG. 5b is a second process flowchart of a server according to another disclosed embodiment; and

FIG. 6 shows one disclosed embodiment.

### DETAILED DESCRIPTION

Disclosed embodiments will be described in more detail below with reference to the appended figures.

FIG. 1 is a diagrammatically shows two mobile stations and a server which cooperate in accordance with one disclosed embodiment.

The mobile stations 101a and 101b belonging to a first user 111a and a second user 111b, respectively, are designed for maintaining a direct mutual communication link 105 from mobile station 101a to mobile station 101b and are at the same time designed for being in communication via 106a and 106b, respectively, with at least one base station 102 that has a communication link 107 so as to form part of a telecommunication network 103. This telecommunication network may be a GSM, UMTS, or any other telecommunication network for mobile communication and may also comprise a data network. The mobile stations 101a, 101b are thus in communication 108 with a server 104 incorporated in or connected to the telecommunication network 103.

Each user 104 has one or more electronic business cards on the server 104. The user is capable of adapting his/her own electronic business card. In addition, the user can store the business cards received from another user via his/her mobile telephone on the server and access these stored business cards via his/her mobile telephone on the server.

Synchronisation may take place between the server and other systems of the user in which the contact data of the business cards are laid down. An example of this is a Personal Computer (PC) 109 which may have a connection 110, 108 to the server 104 via the network 103.

Each user 111a, 111b has a mobile station 101a, 101b, for example a mobile telephone, with which he/she can give his/her business card to other users and can receive electronic business cards from other users. It is possible, immediately upon receipt of an electronic business card, to make a user note by means of and on the mobile telephone, in which note any action to be taken in response later on can be laid down. This note may be stored in the mobile station 101a as well as on the server 104.

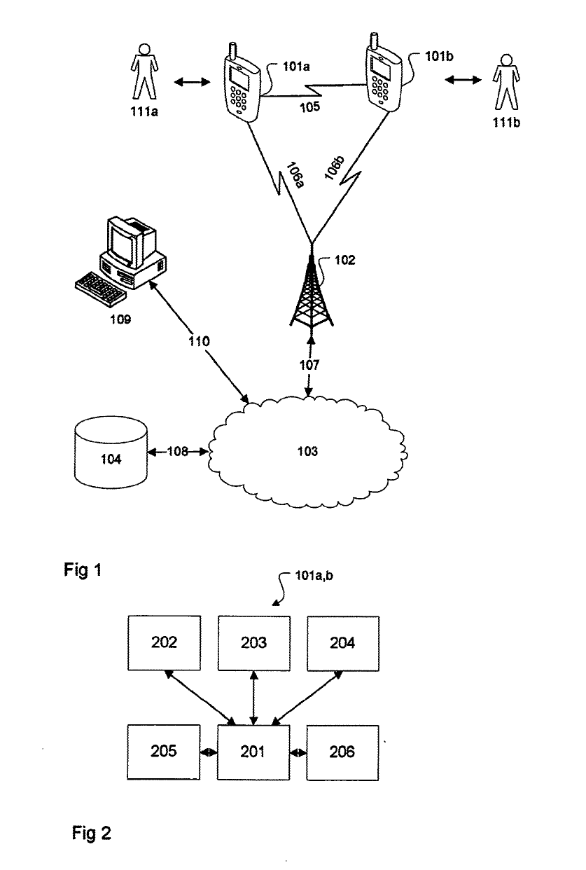

FIG. 2 is a block diagram of a mobile station according to another disclosed embodiment.

A mobile station 101a, 101b according to the disclosed embodiments is built up from a processing unit 201, a first communication unit 202 connected to the processing unit 201, a display unit 203 connected to the processing unit 201, a user data input unit 204 connected to the processing unit 201, a storage unit 205 connected to the processing unit 201, and a second communication unit 206 connected to the processing unit 201.

The mobile station 101a, 101b may be a mobile telephone, a Personal Digital Assistant (PDA), or alternatively a laptop provided with communication means as described further below, or some other mobile station suitable for mobile communication.

The processing unit 201 may be a microprocessor or microcontroller that is coupled to a working storage and a programme memory, which programme memory may be loaded with computer instructions for controlling the mobile station and effecting a cooperation of the various units 202, 203, 204, 205, and 206.

The first communication unit 202 is designed to receive and transmit an electronic business card from and to another mobile station. Such a communication unit may be provided with, for example, a transmitter and receiver suitable for transmitting and receiving signals by various techniques such as Bluetooth, Wireless LAN (WIFI/WLAN), an infrared communication protocol in accordance with the Infrared Data Association (IrDA), or Near Field Communication (NFC). This allows the mobile station to communicate with another mobile station also if it is outside the range of a mobile telephone network. IrDA and NFC may be used for short-range communication, NFC being preferred. NFC is a communication technology based on Radio Frequency Identification (RFID) which enables data exchanges over distances of approximately 10 cm. Various mobile telephones are equipped with NFC nowadays.

The display unit 203 may be a picture screen suitable for the display of messages, such as an LCD screen. It is alternatively possible, however, for the display unit to provide information by acoustic means.

The user data input unit 204 may be a keyboard that cooperates with the processing unit 201 and the display unit 203 for the purpose of entering information. The user data input unit 204 may also be designed for recording user information via speech. A user instruction may be put in, for example, by typing of an instruction in a field shown on the display unit or through a spoken input that is converted into text.

The storage unit 205 may be any externally accessible memory (RAM) or a programmable memory that retains information when the mobile station is switched off. This memory may also be constructed as a memory card that can be removed from the housing of the mobile station such as, for example, an SD card.

The second communication unit may be a transmitter and receiver for mobile internet via, for example, GPRS/EDGE/UMTS/HSDPA, e-mail, Wireless Application Protocol (WAP), Multimedia Messaging Services (MMS) or Short Message Service (SMS).

The user instruction may comprise an executable code that can be read out by the processing unit 201 such that the processing unit 201 carries out a pre-programmed operation. An example of this is the generation and transmission, upon receipt of a first electronic business card, of a second business card from the receiving user to the sender of the first electronic business card. Another example is that the user instruction comprises an executable code for sending a reminder message with coupled thereto a date and/or time when the instruction is to be carried out.

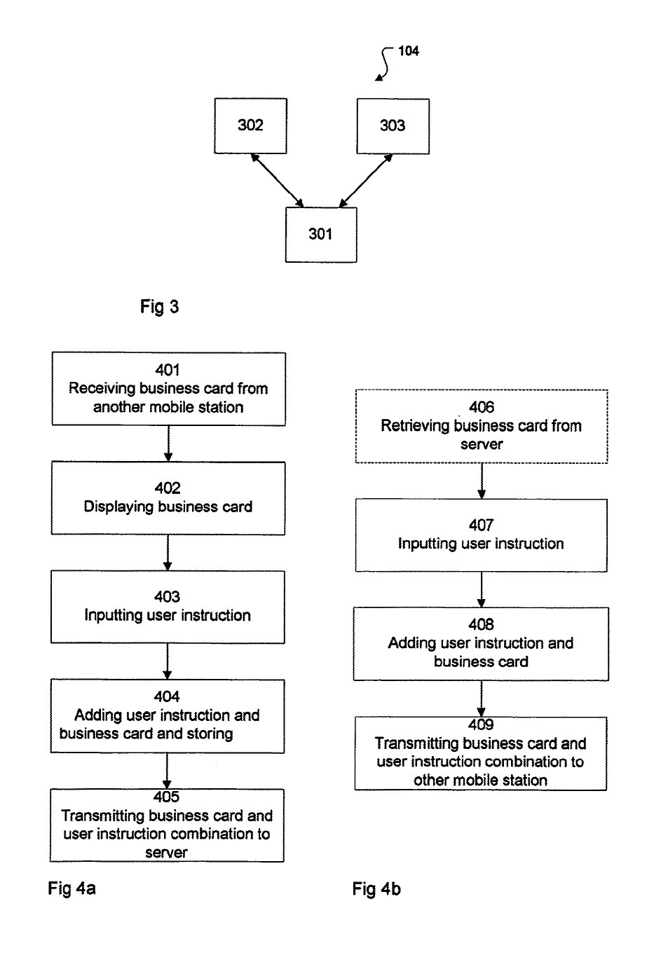

FIG. 3 shows a block diagram of a server according to one disclosed embodiment.

The server 104 comprises mainly a processing unit 301 built up from one or more data-processing processors and a working storage, as is known to those skilled in the art, in which working storage programme instructions executable by the processors are stored so as to have the various components of the server 104 cooperate and carry out the operational steps as described further below. Connected to the processing unit 301 there is a communication unit 302 which enables the server 104 to communicate in a general way with a data network in which other servers and computers may be included, and in particular a with the telecommunication network 103 for communication with mobile stations 101a, 101b such as mobile telephones, PDAs, notebooks and the like. The processing unit 301 is further connected to a storage unit 303 which may comprise a mass storage device such as, for example, a hard disk for the storage of data, as is known to those skilled in the art. These data may be stored in the form of files or be included in a database such that they can be looked up. Various techniques and products are available to those skilled in the art for this application.

In one disclosed embodiment, the storage unit 303 is provided with such a database with a provision therein for the storage of electronic business cards, for example in the “vCard” format. This is the actual standard for electronic business cards of the Internetmail consortium. The invention, however, is not limited to this format; any format may be suitable. The database may contain fields for business card data, a field indicating the owner, the associated use of a mobile station, and one or several status fields for indicating that a reminder message has been sent to the user and that the user has followed up the reminder instructions.

As was described above with reference to the mobile station, the user instruction may comprise an executable code that can be read out by the processing unit 301, whereupon this processing unit 301 carries out a pre-programmed instruction. An example of this is the generation and transmission, upon receipt of a first electronic business card, of a second business card from the receiving user to the sender of the first electronic business card. Another example is that the user instruction comprises an executable code for sending a reminder message with coupled thereto a date and/or time when the instruction is to be carried out. The executable code may indicate whether it is to be carried out by a mobile station or by a server.

FIG. 4a is a flowchart representing the process taking place in a mobile station according to a disclosed embodiment.

In step 401, a mobile station 101a receives a business card from another mobile station 101b, the business card being, for example, in the form of a vCard. The exchange of the business card with the other mobile station 101b takes place, for example, via Bluetooth, IrDA (infrared), wireless internet (WIFI/LAN), or optionally by means of Near Field Communication (NFC) as described above. Alternatively, the exchange of the electronic business card may be effected by means of SMS, MMS, WAP, or e-mail. In step 402, the business card is shown on the screen of the mobile station. In step 403, the user can put in a user instruction, for example via a keyboard by entering a user instruction text or by selecting a user instruction from a pre-programmed list. In step 404, the user instruction is added to the business card and stored in the mobile station for future reference. In step 405, the combination of the electronic business card and the user instruction is sent to the server 104 via the wireless internet link that is present (cf. the description of FIG. 2).

Optionally, in step 401, a user instruction may have been received from the transmitting user. This user instruction may also be shown in step 402 together with the business card. In step 403, the user instruction already present may be modified or replaced, whereupon in step 404 the (possibly modified) user instruction is added to the business card and stored, after which in step 405 the combination with the possibly modified user instruction is sent to the server 104.

FIG. 4b is a flowchart representing the process taking place in a mobile station according to a second disclosed embodiment.

FIG. 4b depicts the transmission of a business card with the associated user instruction to another mobile station. In an optional step 406, an electronic business card may be retrieved from a server 104. This step is optional because the electronic business card may already be present in the mobile station 101a. In step 407, a user instruction is composed, for example via a keyboard or by means of spoken text converted by speech recognition, or through selection of a user instruction from a list comparable to step 403. In step 408, the user instruction is added to the electronic business card, and in step 409 the combination of the business card and the user instruction is sent to another mobile station 101b using IrDA (infrared), Bluetooth, wireless internet (WIFI/LAN), or Near Field Communication (NFC), or alternatively by means of SMS, MMS, WAP, or e-mail.

The electronic business card may have been prepared beforehand on the mobile station 101a or on a PC 109 of the user and be subsequently stored on the server 104 and in the mobile station 101a.

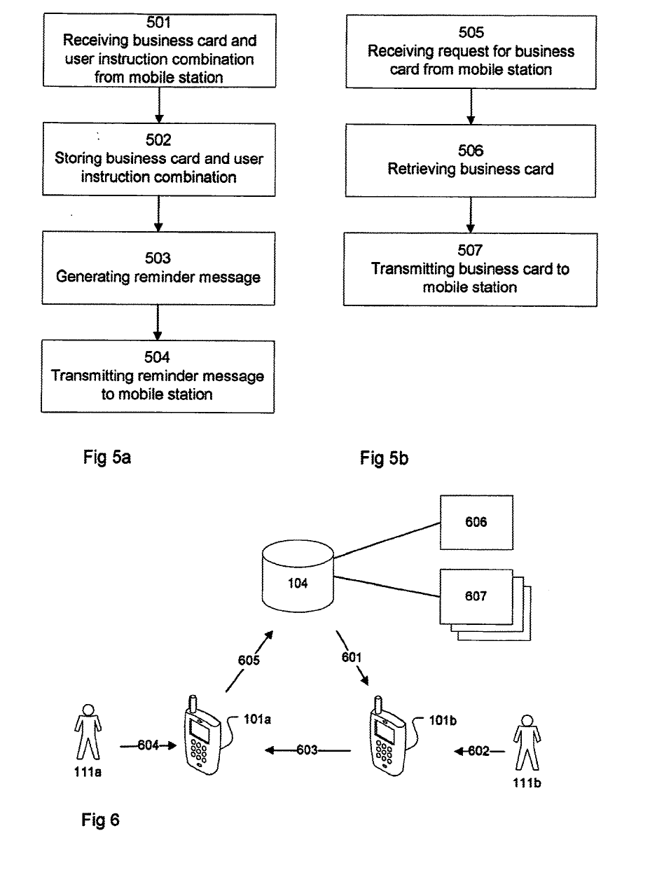

FIG. 5a is a flowchart representing the process taking place in a server according to a disclosed embodiment.

In step 501, which follows the process steps 401 to 405 described above, the combination of the electronic business card and the user instruction is received from the mobile station 101a. In step 502, this combination is stored in the storage unit of the server 104 described with reference to FIG. 3, for example in a database or as a file, or a combination thereof. In step 503, the processing unit 301 of the server 104 searches through the combinations of business cards and user instructions and generates a reminder message for the user of the mobile station 101a. The generation of the reminder message may take place at a fixed moment in time or at a moment determined by the user, which moment may be part of the user instruction. In step 504, the reminder message is sent to the mobile station 101a by the communication unit 302 of the server 104.

FIG. 5b is a flowchart representing the process taking place in a server according to another disclosed embodiment.

Before an electronic business card is sent to another station as described in process steps 406 to 409, wherein in step 406 the electronic business card is retrieved from the server 104, step 505 now comprises the receipt of a request for a business card from the mobile station 101a, the business card belonging to the requesting user. In step 506, the processing unit 301 of the server 104 retrieves the electronic business card from the storage unit 303 of the server 104, for example from the database mentioned above or in the form of a file. In step 507, the communication unit 302 sends the electronic business card to the mobile station 101a.

The steps 505 to 507 may also be used for putting in an electronic business card once more, in which case first an empty business card is retrieved and transmitted to the mobile station, where it is completed by the user and returned to the server 104, and is subsequently stored thereon, as will be apparent to those skilled in the art. It is also possible to modify a previously entered electronic business card in the steps 505 to 507. This will also be clear to those skilled in the art.

FIG. 6 shows one disclosed embodiment.

This disclosed embodiment for the exchange of electronic business cards utilises the possibility of exchanging bookmarks that point to electronic business cards via NFC between the mobile stations 101a and 101b (such as mobile NFC telephones). A bookmark is sent as a “Smart Poster” message consisting of a title and a pointer (URI). In this modification the scenario of the exchange of an electronic business card between user 111b and user 111a runs as follows:

Step 601: user 111b makes a bookmark of a web page of his/her business card once on his/her mobile station. This business card 606 is stored on the server 104. The user 111b can go to this web page by means of a web browser of his/her mobile station 101b, which web browser is programmed such that the user 111b can select, for example, “Options→Start a Bookmark”. It is alternatively possible to send the bookmark to the telephone by SMS, for example after the user 111b has registered via a website (on PC 109). The bookmark is given the name of the web page, for example “Business card user 111b”. The web browser is programmed such that the name of the bookmark can be changed by the user 111b. The bookmark need not be modified when the user 111b changes his/her business card 606 on the server 104. Changing of one's own business card is effected via the website, possibly via a PC 109 or a mobile station 101a, 101b.

Step 602: the mobile station (such as a mobile NFC telephone) may be programmed such that, when the user 11b wants to give his/her business card 606 to another user, for example user 101a, he/she will select an option provided in his/her mobile telephone (mobile NFC telephone), for example: “NFC→Share with other device→bookmark→business card user 111b”. The mobile station will then try, for example during 60 seconds, to send the bookmark to another NFC device.

Step 603: When the user 111b and the user 111a hold their telephones close together, an NFC module of the mobile station 101b will send a bookmark from mobile station 101b to mobile station 101a.

Step 604: upon reception at the mobile station 101a via an NFC module, the user 111a receives a message, for example “Open URL, business card user 1, http:\\www.business cards.nl:ID+001234”. The standard option may then be to open this URL. It is also possible to store the internet link (URL) and open it later.

Step 605: if the user 111a opts for opening the URL, the web browser on the mobile station 101a is started and the web page belonging to the business card of user 111b is loaded. Now the server 104 can add the business card of user 111b to the collection of business cards 607 of user 111a. Various functions may be offered in addition to the display of the business card, such as choosing a user instruction from a list by way of follow-up, registering with a mobile service, and sending the business card received from user 111b to the mobile station 101a.

The embodiments described herein are merely examples of how the invention may be put into practice. Adaptations, modifications and changes are possible without departing from the scope of the disclosed embodiments as set out below in the claims.

1. A mobile station of a first user arranged for exchanging an electronic business card with another mobile station, the first mobile station comprising:
a processing unit for controlling the mobile station;
a first communication unit connected to the processing unit and arranged for receiving a first electronic business card from the other mobile station, i.e., from a second user;
a display unit connected to the processing unit and arranged for displaying the first electronic business card;
a user data input unit arranged for receiving an input of a first user instruction from the first user;
a storage unit connected to the processing unit for combining and storing a combination of the first electronic business card and the first user instruction in the mobile station;
a second communication unit connected to the processing unit for transmitting the first electronic business card with the associated first user instruction to a server;
wherein the user data input unit is furthermore arranged for enabling the first user to enter a second user instruction;
wherein the processing unit is furthermore arranged for adding the second user instruction to a second electronic business card stored in the storage unit; and
wherein the first communication unit is furthermore arranged for transmitting the combination of the second electronic business card and the second user instruction to the other mobile station or a still further mobile station.

2. The mobile station according to claim 1, wherein the reception or transmission of the first or the second electronic business card from or to the other mobile station, respectively, by the first communication unit also comprises the reception or transmission of a reference to the first or the second electronic business card present on the server.

3. The mobile station according to claim 1, wherein the first communication unit is furthermore arranged for receiving from the other mobile station a third user instruction that belongs to the first business card.

4. The mobile station according to claim 3, wherein the user data input unit is furthermore arranged for modifying the third user instruction.

5. The mobile station according to claim 1, wherein the user data input unit is furthermore arranged for enabling the user to select from a list at least one from among the first, the second, and the third user instruction.

6. The mobile station according to claim 1, wherein at least one from among the first, the second, and the third user instruction comprises an instruction to be executed by at least one from among the processing unit of the mobile station and a processing unit of the server.

7. The mobile station according to claim 6, wherein the executable instruction comprises a reminder instruction, and wherein the processing unit is further arranged for generating a reminder message that can be shown on the display unit.

8. The mobile station according to claim 7, wherein the generation of the reminder message comprises a reception of a reminder message from the server by the second communication unit.

9. The mobile station according to claim 8, wherein the input unit is further arranged for enabling the user to enter a selection request for receiving a selection of reminder messages, wherein the second communication unit is further arranged for transmitting the selection request to the server and receiving said selection from the server, and wherein the display unit is further arranged for displaying said selection.

10. The mobile station according to claim 9, wherein the selection request comprises an indication of at least one user.

11. The mobile station according to claim 1, wherein the first communication unit of the mobile station is specially constructed for communication over a distance lying in a range of between 0 and 1 metre.

12. The server specially arranged for cooperating with a mobile station, comprising:
a processing unit for controlling the server;
a communication unit for receiving from a mobile station a combination of an electronic business card and an associated user instruction; and
a storage unit arranged for storing the electronic business card and the associated user instruction;
wherein the processing unit is arranged for generating at least a reminder message; and
wherein said reminder message comprises the electronic business card and the associated user instruction, and the communication unit is further arranged for transmitting the reminder message to the mobile station.

13. The server according to claim 12, wherein the processing unit and the storage unit are furthermore arranged for composing a selection of reminder messages, and the communication unit is furthermore arranged for sending this selection of reminder messages to the mobile station.

14. The server according to claim 13, wherein the communication unit is furthermore arranged for receiving a request from the mobile station to send a selection of not yet processed reminder messages.

15. The server according to claim 13, wherein the communication unit is furthermore arranged for receiving a selection request from the mobile station to send a selection of reminder messages associated with at least one user, the processing unit and storage unit being arranged for making a selection on the basis of the at least one user on behalf of whom an electronic business card is stored.

16. The server according to claim 13, wherein the communication unit is furthermore arranged for transmitting the selection of reminder messages at a predetermined moment in time.

17. The server according to claim 12, wherein the user instruction comprises an instruction that is to be executed by the processing unit, which processing unit is furthermore arranged for processing the executable instruction.

18. The server according to claim 12, wherein the storage unit is furthermore arranged for storing a confirmation check on the execution of the associated user instruction along with the electronic business card, and the communication unit is furthermore arranged for receiving said confirmation check from the mobile station such that electronic business cards with a confirmation check are not included in the selection.
